(19) United States
(12) Patent Application Publication
(10) Pub. No.: US 2011/0305114 A1
(43) Pub. Date: Dec. 15, 2011

(54) SEISMIC SURVEY COMMUNICATION SYSTEMS AND METHODS

(76) Inventors: Daniel Golparian, Tokyo (JP); Guillaume Tamboise, Oslo (NO); Sharath Babu Musunoori, Lysaker (NO); Kevin O'Connell, Asker (NO)

(21) Appl. No.: 13/156,723

(22) Filed: Jun. 9, 2011

Related U.S. Application Data
(60) Provisional application No. 61/353,863, filed on Jun. 11, 2010.

(51) Int. Cl. G01V 1/22

(52) U.S. Cl. 367/77

(57) ABSTRACT

An embodiment of the invention may extend the range of wireless communications in a seismic acquisition survey. The embodiment may leverage the infrastructure of a hard-wired communications backbone by appending wireless cells to the hard-wired communications. This may allow, for example, a recording truck to control remotely located seismic sources via wireless communications in the spread. Another embodiment includes a communication system for servicing field equipment. The embodiment provides for a fully or semi automated process for communicating equipment failures between survey personnel (e.g., recording truck operators and line observers). The embodiment establishes an end-to-end channel between, for example, the recording truck and field crew members. Other embodiments are disclosed herein.

This application claims priority to U.S. Provisional Patent Application No. 61/353,863 filed on Jun. 11, 2010 and entitled “Network Gateway for Seismic Acquisition”, the content of which is hereby incorporated by reference.

### BACKGROUND

Seismic exploration may utilize a seismic energy source to generate acoustic signals that propagate into the earth and partially reflect off subsurface seismic reflectors (e.g., interfaces between subsurface layers). The reflected signals are recorded by sensors (e.g., receivers or geophones located in seismic units) located near the surface of the earth. The recorded signals (including seismic energy data) can be processed to yield a seismic survey. The sensors may be laid out in a “spread” that covers a large area. Hundreds to thousands of sensors may be deployed in a grid configuration where, for example, a line of sensors extends 5,000 meters with sensors spaced every 25 meters and sensor lines spaced 200 meters apart. Spreads may cover over 700 square kilometers (e.g., spread layout of 70 sensor lines, 27 kilometers/line, with lines 400 meters apart).

In a spread, transmission systems couple sensors to a control station or data recording terminal (e.g., a recording truck or unit). The control station may transmit control signals to source units (e.g., vibrator) and collect data (e.g., seismic data, quality control data) related to the sensors and spread. Also, sensors may transmit data to an intermediate data collection station (e.g., concentrator) where data is recorded and stored until retrieved. Some systems store seismic data at a various points in the spread but immediately transmit quality control data back to the control station.

Hard-wired cable telemetry may be used for data transmission between individual sensors, stations that include or couple to the sensors, and a control station or stations. Sensors may be connected in a parallel and/or series using a twisted pair of wires to form a single sensor group or channel for a station. During data collection the output from each channel may be digitized and recorded by the station for subsequent analysis. In turn, stations may use cables to communicate the collected data to recorders located at, for example, the control station (e.g., recording truck or unit) or concentrator station.

However, wireless systems may also transmit data between individual sensors, stations, and a control station or stations (e.g., recording truck). For example, a seismic sensor may utilize radio transmission (e.g., mid-range or long range) to communicate with a central control station or concentrator via a transmitter coupled to the sensor. Transmissions may be made directly between the sensor and the control station or directly between the sensor and a concentrator. High power transmissions (e.g., long-range signals between a seismic acquisition unit, such as a sensor, and a central control station) may require a license from a local governing authority and may have high power requirements that require large battery packages. Low power transmissions may require line-of-sight communication.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a seismic spread in an embodiment of the invention.

FIG. 2 includes a gateway system in an embodiment of the invention.

FIG. 3 includes a communication method in an embodiment of the invention.

FIG. 4 includes a communication system in an embodiment of the invention.

FIG. 5 includes a processor-based system for use with processor-based networks in embodiments of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

In an embodiment a communications “gateway” may create and/or extend the range of wireless communications in a seismic acquisition survey. The gateway may leverage the infrastructure of a hard-wired communications backbone by appending wireless cells to the hard-wired communications. Considering the spread can cover hundreds of square kilometers, the gateway may help locate wireless cells within and/or on the borders of the spread. Field personnel (e.g., based on foot, in a rover vehicle, in a mobile vibrator, etc.) and/or field equipment (e.g., seismic source such as a vibrator) may communicate within the wireless cell, which then transmits the communication to a core location (e.g., recording or control truck or unit) via the hard-wired (fully or partially) backbone. The communication may traverse various wireless and/or wired portions of the spread. The data may include seismic data but may also include non-seismic data, such as an instant message (IM) between a field technician and personnel in the control truck. The gateway may: (1) provide electrical power to telecommunications equipment (e.g., off-the-shelf telecommunications equipment), and/or (2) couple the spread to the wireless cell and its corresponding telecommunications equipment.

An embodiment of the invention includes a communication system for servicing field equipment. As explained above, a spread can cover a wide area. Quickly disseminating information (e.g., a sensor malfunction) throughout the spread can lead to more uptime and more efficient surveying. To this end, good coordination is needed between fault observers (e.g., a user located in the recording truck monitoring equipment fault indicators) and field personnel that fix/replace the faulty field equipment. An embodiment of the system provides a fully or semi automated process for communicating sensed issues (e.g., equipment failures) between survey personnel (e.g., recording truck operators and line observers). The system establishes an end-to-end channel between, for example, the recording truck and field crew members.

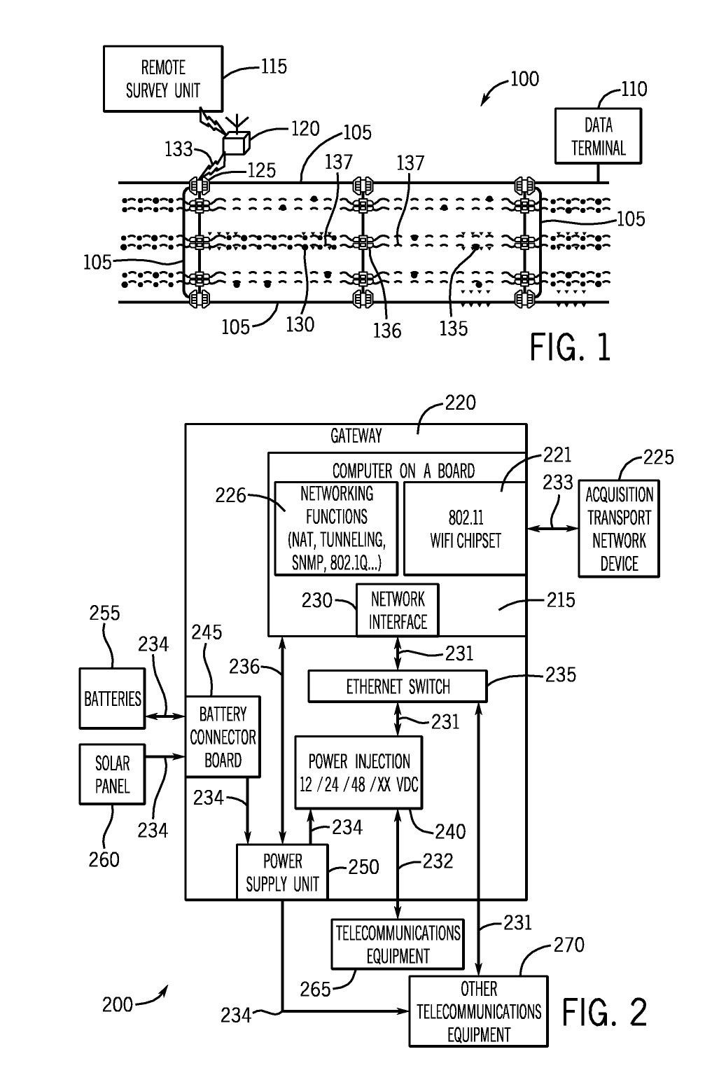

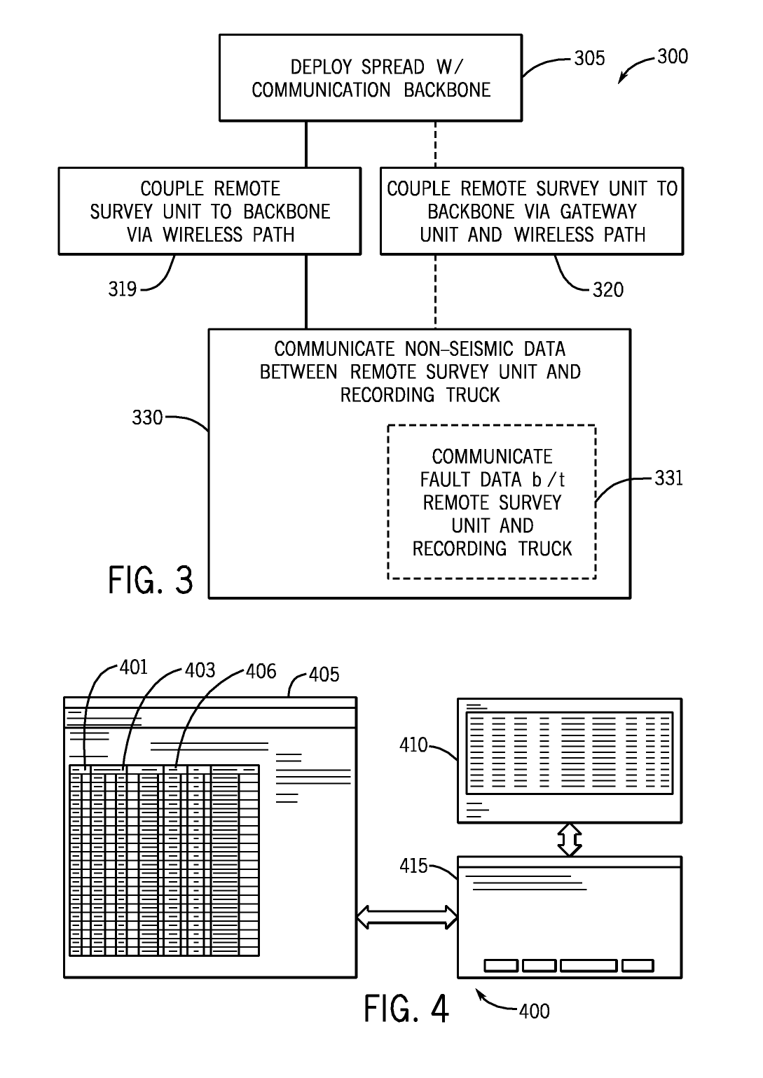

FIG. 1 includes a seismic spread 100 in an embodiment of the invention. FIG. 2 includes a gateway system 200 in an embodiment of the invention. FIG. 3 includes a communication method 300 in an embodiment of the invention. FIGS. 1-3 are discussed below.

Block 305 of method 300 includes deploying a seismic acquisition spread, such as spread 100. The spread may be any number of sizes, such as ranging from 1 to 1,000 square kilometers. For example, the spread may cover about 50 square kilometers or about 750 square kilometers. Spread 100 may include backbone 105 communicatively coupled (i.e., via hardwire or wireless path(s)) between sensors 130, 135, seismic data recording terminal 110, and remote survey unit 115.

Data terminal 110 may take any of several forms. For example, terminal 110 may be included in a recording truck, trailer, vehicle, stationary post, concentrator, repeater, and the like.

Remote survey unit 115 is a general term used to include, for example, a handheld terminal, laptop, netbook, Personal Digital Assistant, smart phone, radio, cell phone, wireless node, tablet, and the like. Thus, a “remote survey unit” may refer to a wireless communication device. However, “remote survey unit” may also refer to a crew member on foot (e.g., a crew member walking about the spread communicating via a handheld terminal) and/or a crew member traveling in a crew vehicle (e.g., a person on/in a scooter, truck, ATV using a handheld terminal), seismic source (e.g., a person in/on/near a vibrator or static source communicating with a handheld terminal), and the like. The term “remote survey unit” further includes the presence of a laptop, netbook, Personal Digital Assistant, smart phone, radio, cell phone, wireless node, tablet in a vehicle (e.g., scooter, truck, ATV), seismic source (e.g., vibrator or static source), and the like. Such equipment may function and communicate with, for example, the backbone and recording terminal in an automated fashion with little to no human assistance.

A backbone may include a larger part of a network that is used to connect smaller segments of the same network together. Backbones may carry higher-bandwidth concentrated traffic between, on, and off ramps of a network. Backbones may include nodes interconnected via high bandwidth hardwired connections that allow for high bandwidth data communications. Such connections may include, for example, twisted wire pairs, shielded coaxial cables, fiber optic cables, and various high or medium bandwidth connectors or paths. Thus, in an embodiment a backbone includes a network for communication transmission that carries major traffic between smaller networks. Backbones may span many yards or miles of dedicated lines. The lines or wires carry major communications traffic within a network. Backbones may include varying degrees of hardwired connections so that varying levels of wireless paths are included in the backbone provided the capacity for medium or high bandwidth traffic is facilitated.

There can be thousands of sensors in a spread but only sensors 130, 135 are labeled for purposes of clarity. Power module 136 may couple sensors 130, 135 to backbone 105 via lines 137. Power module 136 (of which only one is labeled) may convert power to another level suitable for sensors 130, 135. Module 136 may include solar panels, batteries, and/or connect to a main power supply via the backbone 105. Module 136 may further include communications hubs and paths (e.g., fiber optic cables) to communicate data between (to and from) sensors 130, 135 and backbone 105 and generally within the spread. Module 136 may further include a communication hub using a protocol, such as WiFi, to couple to gateway 120 and/or handheld wireless terminals (addressed further below).

Block 320 includes coupling a remote survey unit to a backbone via a gateway unit and wireless path. For example, communication gateway system 120 may be communicatively coupled between backbone 105 and a wireless communication member (e.g., WiMAX access point, a VHF radio, and a WiFi access point) included in or coupled to gateway 120. Specifically, in the embodiment of FIG. 2 gateway system 220 couples to acquisition transport network device 225 (125 in FIG. 1), such as might be included in or coupled to a node (e.g., simple node, concentrator, repeater, router). As used herein references to network device 125 or 225 may also be read to include power module 136, which may include a wireless networking capacity for coupling a spread component (e.g., backbone) to a wireless device (e.g., handheld terminal). Thus, gateway system 220 may couple to, for example, acquisition transport network device 225 (125 in FIG. 1) and/or power module 136. Also, while many acquisition transport network devices and power modules may be included in spread 100, only devices 125 and 136 are labeled for purposes of clarity.

Spread 100, network device 125, and/or module 136 may be included in a seismic acquisition network built on an open protocol. Embodiments of exemplary networks are described in commonly assigned U.S. Pat. No. 7,898,904, which is entitled “Implementing a Network Infrastructure in a Seismic Acquisition System” and is hereby incorporated by reference. Regarding FIG. 2, gateway 220 may communicatively couple with network device 225 via WiFi (e.g., 802.11) path 233 (133 in FIG. 1) and WiFi chipset 221. However, in other embodiments gateway 220 may couple to the spread using, for example, any of various short range wireless protocols or even via a hard-wire connection (through which communication cabling may be supplied from backbone 105 to gateway 220).

Gateway 220 may couple, via a wired or wireless connection, to off-the-shelf telecommunication equipment or wireless node 265, 270 (e.g., WiMAX access point, VHF/IP radio, WiFi access point, and the like).

Gateway 220 may receive power from the spread. However, gateway 220 may supply (fully or partially) its own power via solar panel 260 and/or batteries 255 (e.g., car batteries). Battery(ies) 255 may be recharged by panel 260. Power may be conveyed from such a source to gateway 220 via battery connector board 245 and power supply unit 250. Via power supply unit 250, gateway 220 may supply power at varying voltage levels to coupled telecommunications equipment (e.g., equipment 270) so that gateway 220 can accommodate various types of telecommunications equipment (which may collectively require varying voltage supplies). Unit 250 may monitor the power status of the gateway and of telecommunications device 265, 270 and send related information to monitoring/recording unit 110 via network device 225 and TCP/IP. Further, gateway 220 may report its own operational status (e.g., wireless signal strength) as well as the operational status of off-the-shelf telecommunication equipment 265, 270.

Gateway 220 may include a TCP/IP stack in its computer-on-a-board 215 and may perform basic network functions via module 226 (e.g., Ethernet bridging, IP routing (e.g., including participation in a dynamic routing protocol), network address translation, relay application-layer network management data, use varying protocols (e.g., RFC 2962), and the like). Gateway 220 may couple to or include power sources, telecommunications equipment (e.g., wireless nodes based on VHF, WiMax, WiFi, and the like included in equipment 265, 270) and the like via any number of coupling mechanisms such as, without limitation, Ethernet (via Ethernet switch 235 and network interface 230) via regular Ethernet path 231, power over Ethernet via unit 240 and path 232, WiFi via path 233, power via paths 234 and 236, twisted pair cabling, and the like.

In an embodiment, a wireless gateway node may include gateway 220 and telecommunications equipment 265, 270 in a combined module or in separate modules coupled to one another. The wireless gateway node may further include modules 255, 260 or merely couple to them. As such, various embodiments of the invention allow for varying levels of physical partitioning among components or modules used to couple wireless cells to hardwired backbones.

Backbone 105 may be hardwired to unit 110 and/or sensors 130, 135 and/or nodes (e.g., network device 125). However, backbone 105 may also be wirelessly coupled to unit 110 and/or sensors 130, 135 to varying degrees.

Block 330 includes communicating non-seismic data from the remote survey unit 115 to seismic data recording terminal 110 via backbone 105. In an embodiment, gateway 120 (wirelessly coupled to network device 125) may be mobile and located in, for example, a vehicle. Thus, a communication member (e.g., wireless system included in gateway 120) may help a field agent (e.g., person who checks equipment functioning in the spread) use his or her mobile unit to wirelessly communicate with gateway 120 and then through the spread (e.g., along backbone 105 or even hopping from among various network devices 125) to unit 110, which may be located beyond line-of-sight from the field agent (e.g., more than 30 kilometers).

While gateway units are discussed herein, various embodiments do not necessarily include a specific embodiment of the gateway unit. A wireless may be appended to the backbone without necessarily using a gateway unit. For example, a crew member with a handheld terminal may wirelessly communicate with a gateway unit and then to the control truck via the backbone. However, block 319 includes coupling a remote survey unit to the backbone via a wireless path without using a gateway unit. For example, a crew member with a handheld terminal may also wirelessly communicate directly with unit 125 and/or 136, each of which include networking equipment (e.g., antenna and cellular communications modules) to couple the crew member to the spread (e.g., recording terminal). No gateway unit would necessarily be required when the handheld unit communicates directly with, for example, unit 125 and/or 136.

An embodiment of the invention includes communicating non-seismic data (e.g., a sweep start time) between a data terminal (e.g., recording or control truck) and a backbone and communicating the non-seismic data, via a wireless path (which may or may not be based on a gateway unit) between the backbone and a remote survey unit (e.g., vibrator). Then, a seismic survey may be conducted based on the remote survey unit receiving the non-seismic data via the wireless path. Non-seismic data may take the form of, for example, IM, voice, e-mail, data files, text, Extensible Markup Language (XML) documents, and the like.

In an embodiment, a data terminal may control a seismic activity of a remote survey unit via communicating non-seismic data over the backbone and the wireless path. For example, the remote survey unit may include a seismic vibrator, the data terminal may communicate seismic survey start time information to the seismic vibrator; and the vibrator may conduct the seismic survey based on the survey start time information.

In an embodiment, a method may include conducting a first portion of the seismic survey (e.g., a first sweep from a first location) based on a remote survey unit (e.g., mobile vibrator) receiving non-seismic data (e.g., sweep characteristics information) via a first wireless cell appended to the backbone (e.g., via a gateway unit or via a more direct route to unit 125 or 136 without using a gateway unit); and conducting a second portion of the seismic survey (e.g., a second sweep from a second location) based on the remote survey unit receiving additional non-seismic data (e.g., additional sweep characteristics information) via a second wireless cell appended to the backbone (e.g., via a gateway unit or via a more direct route to unit 125 or 136 without using a gateway unit). For example, the vibrator may move about the spread hopping from one cell to another cell. By using different cells (each appended to the spread) the vibrator may stay in communication with the control truck despite moving about different locations of the spread. Thus, a control truck may send sweep information to the vibrator to perform various sweeps at various locations in the spread.

While not previously mentioned, seismic data may be communicated from sensors 130, 135 to backbone 105. The seismic data may be communicated between sensors 130, 135 themselves and between sensors 130, 135 and backbone 105 via a hard-wired non-wireless path and/or a wireless path.

Block 331 (optional) may include communicating non-seismic data that includes fault data. The fault data may be communicated between a remote survey unit and a recording truck. A related embodiment is described more fully in regard to FIG. 4.

FIG. 4 includes a communication system 400 in an embodiment of the invention. Regarding FIGS. 1, 3, and 4, block 330 includes communicating non-seismic data between units 110, 115 (e.g., from 110 to 115 and/or from 115 to 110). One form of non-seismic data includes fault data. For example, various forms of fault data (e.g., instrument test failures, external power device failures, hazardous gas detection, etc.) may be communicated. The fault data may include failures related to units 125 and/or 136 (e.g., node or station connectivity lapses). Fault data may also include sensor fault data. For example, sensors 130, 135 may include devices for detecting fault information related to (a) sensor malfunction (e.g., excessive tilting, inadequate power or communication), and/or (b) overall inadequacy for seismic acquisition (e.g., unacceptable noise, humidity, vibration, temperature, and the like). Corresponding “fault data” may be sent from, for example, a sensor or communication unit (e.g., 125 and/or 136) to the backbone and on to unit 110. An operator in unit 110 may note the fault and “push” (automatically or non-automatically) additional fault data (e.g., an IM directing field personnel to adjust the inclination angle of the faulty sensor) from unit 110 to backbone 105, network device 125, gateway 120 (which may or may not be included in the system), and on to remote survey unit 115 via a wireless path or cell. Again, unit 115 may receive fault data via a gateway unit or may receive the data directly via, for example, units 125 and/or 136.

Data communicated to/from units 115 and 110 is not restricted to fault data but may include, for example, any type of data including scheduling information, basic communications (e.g., via IM, email, voice, Voice over Internet Protocol (VOIP), XML documents, text, image, video), power status, environmental conditions near a sensor (e.g., noise, humidity, vibration, temperature), and the like. The data may be communicated to/from unit 115 via any of various protocols (e.g., Extensible Messaging and Presence Protocol (XMPP) such as OpenFire, Session Initiation Protocol for Instant Messaging and Presence Leveraging Extensions (SIMPLE), VOIP, Session Initiation Protocol (SIP), Talk to OSCAR (TOC), Rendezvous Protocol (RVP), and Yahoo! Messenger Protocol (YMSG)).

In an embodiment, system 400 may determine a physical proximity of unit 115 to a node, such as a 130. System 400 may further determine a physical proximity of another mobile communications device (not shown) to the node, such as sensor 130. The system may determine which unit is closer to sensor 130 and then communicate fault data (e.g., the location and identification of sensor 130) to unit 115 based on determining unit 115 is closest to sensor 130. Proximity may be determined based on, for example, GPS technology, “presence” data (addressed below), and the like.

In an embodiment, system 400 may determine presence data for various field units (e.g., 115) and then communicate fault information to one of the units whose presence data indicates the unit is available for service. Actual selection from among the field units (regarding which one to send fault information to) may be based on the determination of presence data for the field units. For example, maybe only one unit is present or available. Unit 110 may then decide to necessarily communicate fault data to the one and only “present” unit. However, multiple units may be present or available but one of the units is closest to the faulty equipment (e.g., faulty node, faulty sensor) so the closest unit is sent the fault data. Sending fault data just to the closest unit may help avoid sending fault information to units that will not be selected to address the fault issue (and do not need to be distracted by such data).

Also, presence information or data may also include multiple points of presence (MPOP) information. Thus, a field worker may have MPOP information covering his Smartphone (e.g., is phone on, is phone connected to backbone, does phone have a GPS determined location), laptop (e.g., is laptop on, is laptop connected to backbone, does laptop have a GPS determined location), and the like. System 400 may detect one field worker is present on her smart phone while another worker is present on his laptop. System 400 may then choose, for example, the worker present at his laptop (and presumably near his vehicle) to service a station because the worker on the smart phone is more likely already occupied with a task. On a related note, presence data may also include whether a worker is already engaged in servicing equipment.

Furthermore, system 400 may be automated to various levels. For example, a sensor fault may automatically be sent to unit 110. However, unit 110 may require user intervention. As another example, upon receiving several error communications a user of unit 110 may decide to push messages (corresponding to the error) to certain field workers but not to others. However, doing so may be more fully automated. For example, error data may automatically be communicated to users that are (a) “checked in” as being “present” and ready to accept work and (b) closer to the troubled sensor than any other “checked in” field worker. Also, when a user nears a sense station (e.g., 130) the user's presence may automatically be noted (i.e., user is determined “present”) as being proximate to the station (e.g., based on Bluetooth communication between sensor station 130 and mobile unit 115), and such proximity information may be automatically sent to unit 110.

In an embodiment, system 400 may be used separate and apart from gateway 120 embodiments. Instead, system 400 may communicate data (e.g., equipment failure communications) between units 110, 115 by hopping from sensor station or network device to adjacent sensors or network devices, all of which may include wireless communication capacity. Also, data transfer between units 115 and 110 may be synchronous or asynchronous (to allow an offline user to receive pent up information once he or she is again online). For example, once a user moves close to station 130 (and/or device 125 and/or gateway 120) and has his status consequently changed to “present” then error data for station 130 (and surrounding stations in some embodiments) may automatically be pushed to the worker's unit (e.g., 115) or pulled from unit 110.

In FIG. 4, graphical user interface (GUI) 405 is for unit 110 wherein an operator can observe errors and tie those errors to various columns such as 401 (equipment line number), 403 (sensor tilt angle), and 406 (sensor identification number). GUI 405 may indicate users 1 and 2 are “present” and ready for work. In an embodiment, box 415 includes an extensible messaging and presence protocol server, which acts as an interface between GUIs 405, 410. GUI 410 shows much of the same equipment status data as GUI 405. GUI 410 may be deployed on a PDA or smart phone of the field worker. Thus, system 400 illustrates a usage scenario which enables observers (e.g., unit 110) and line checkers (e.g., unit 115) to get an overview of other line checkers and observers while exchanging equipment failures and using IM, for example, to further communications efforts.

Thus, in an embodiment system 400 provides a basic set of services to help observers and line checkers to identify a worker's status and then exchange information regarding equipment failures via IM or other communication protocols. System 400 may do so by providing: (1) presence service, (2) communications (e.g., chat/IM), and (3) transfer of status information (e.g., weather, climate, environmental noise, sensor tilt failures).

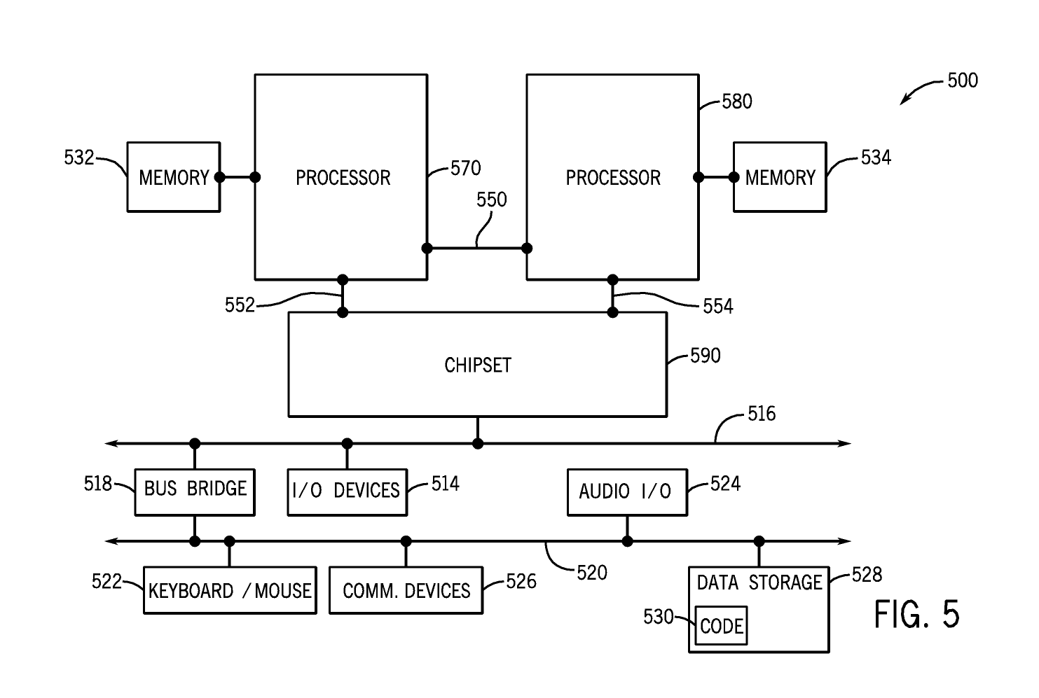

Embodiments may be implemented in many different system types. Referring now to FIG. 5, shown is a block diagram of a system for use with various embodiments (e.g., system 100, system 200, method 300, and system 400) of the present invention. Multiprocessor system 500 is a point-to-point interconnect system, and includes a first processor 570 and a second processor 580 coupled via a point-to-point interconnect 550. Each of processors 570 and 580 may be multicore processors. The term “processor” may refer to any device or portion of a device that processes electronic data from registers and/or memory to transform that electronic data into other electronic data that may be stored in registers and/or memory. First processor 570 may include a memory controller hub (MCH) and point-to-point (P-P) interfaces. Similarly, second processor 580 may include a MCH and P-P interfaces. The MCHs may couple the processors to respective memories, namely memory 532 and memory 534, which may be portions of main memory (e.g., a dynamic random access memory (DRAM)) locally attached to the respective processors. First processor 570 and second processor 580 may be coupled to a chipset 590 via P-P interconnects, respectively. Chipset 590 may include P-P interfaces. Furthermore, chipset 590 may be coupled to a first bus 516 via an interface. Various input/output (I/O) devices 514 may be coupled to first bus 516, along with a bus bridge 518, which couples first bus 516 to a second bus 520. Various devices may be coupled to second bus 520 including, for example, a keyboard/mouse 522, communication devices 526, and data storage unit 528 such as a disk drive or other mass storage device, which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. For purposes of this disclosure, the terms “code” or “program” cover a broad range of components and constructs, including applications, drivers, processes, routines, methods, modules, and subprograms. Thus, the terms “code” or “program” may be used to refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
communicating non-seismic data between a data terminal and a backbone that are both included in a seismic spread;
communicating the non-seismic data, via a wireless path, between the backbone and a remote survey unit; and
conducting a seismic survey based on the remote survey unit receiving the non-seismic data via the wireless path.

2. The method of claim 1, wherein (a) the remote survey unit is one of a handheld terminal, mobile seismic vibrator, a static seismic vibrator, a static seismic source, and a field crew vehicle, and (b) the data terminal is one of a data recording truck and a static data recording terminal.

3. The method of claim 1 including the data terminal controlling a seismic activity of the remote survey unit via communicating the non-seismic data over the backbone and the wireless path.

4. The method of claim 1 including communicating non-seismic data (a) from the remote survey unit to a wireless gateway node (WGN) via the wireless path; and then (b) to the data terminal via the backbone.

5. The method of claim 4 including appending a wireless cell to the backbone based on the WGN.

6. The method of claim 1 including:
conducting a first portion of the seismic survey based on the remote survey unit receiving the non-seismic data via a first wireless cell appended to the backbone; and
conducting a second portion of the seismic survey based on the remote survey unit receiving additional non-seismic data via a second wireless cell appended to the backbone.

7. The method of claim 1, including communicating the non-seismic data, via the wireless path, directly between the remote survey unit and a communication node coupled to the backbone.

8. The method of claim 1, wherein:
the remote survey unit includes a seismic vibrator;
communicating the non-seismic data between the backbone and the remote survey unit includes communicating seismic survey start time information to the seismic vibrator; and
conducting the seismic survey includes conducting the seismic survey with the seismic vibrator based on the survey start time information.

9. The method of claim 1 including communicating fault data from a first node included in the seismic spread to the data terminal, and additional fault data from the data terminal to the backbone and then to the remote survey unit via the wireless path.

10. The method of claim 9 including communicating the additional fault data to the remote survey unit via a protocol selected from the group consisting of XMPP, SIMPLE, TOC, RVP, VOIP, SIP, and YMSG; wherein the additional fault data is one of XML, text, image, video, instant message, and voice data.

11. The method of claim 9 including:
determining a first physical proximity of the remote survey unit to the first node and a second physical proximity of another remote survey unit to the first node; and
communicating the additional fault data to the remote survey unit based on the first physical proximity being less than the second proximity.

12. The method of claim 9 including determining presence data for the remote survey unit, and communicating the additional fault data to the remote survey unit based on the determined presence data.

13. A seismic acquisition system comprising:
a seismic spread including a backbone to communicatively couple a data terminal with a remote survey unit; and
a processor-based network, coupled to the spread, operable to (a) communicate non-seismic data between the data terminal and the backbone; (b) communicate the non-seismic data, via a wireless path, between the backbone and the remote survey unit; and (c) conduct a seismic survey based on the remote survey unit receiving the non-seismic data via the wireless path.

14. The system of claim 13, wherein (a) the remote survey unit is one of a handheld terminal, mobile seismic vibrator, a static seismic vibrator, a static seismic source, and a field crew vehicle, and (b) the data terminal is one of a data recording truck and a static data recording terminal.

15. The system of claim 13, wherein the data terminal is operable to control a seismic activity of the remote survey unit via communicating the non-seismic data over the backbone and the wireless path.

16. The system of claim 13, wherein the network is operable to (a) conduct a first portion of the seismic survey based on the remote survey unit receiving the non-seismic data via a first wireless cell coupled to the backbone; and (b) conduct a second portion of the seismic survey based on the remote survey unit receiving additional non-seismic data via a second wireless cell coupled to the backbone.

17. The system of claim 13, wherein the network is operable to communicating the non-seismic data, via the wireless path, directly between the remote survey unit and a communication node coupled to the backbone.

18. The system of claim 13, wherein the network is operable to communicate (a) sensor fault data from a first sensor included in the spread to the backbone and the data terminal; and (b) additional sensor fault data from the data terminal to the backbone, and then to the remote survey unit via the wireless path.

19. The system of claim 18, wherein the network is to:
determine a first physical proximity of the remote survey unit to the first sensor and a second physical proximity of another remote survey unit to the first sensor; and
communicate the additional sensor fault data to the remote survey unit based on determining the first physical proximity is less than the second proximity.

20. The system of claim 18, wherein the network is to determine presence data for the remote survey unit, and communicate the additional sensor fault data to the remote survey unit based on the determined presence data.

21. An article comprising a non-transitory medium storing instructions that enable a processor-based system to:
communicate fault data from a first node to a backbone and a data terminal; wherein the first node, the backbone, and the data terminal are included in a seismic spread and the backbone is to communicatively couple the first node and a second node to the data terminal; and
communicate additional fault data from the data terminal to the backbone and then to a remote survey unit via a wireless path.

22. The article of claim 21 storing instructions that enable the system to communicate the additional fault data to the remote survey unit via a protocol selected from the group consisting of XMPP, SIMPLE, TOC, RVP, VOIP, SIP, and YMSG; wherein (a) the second fault data is one of XML, text, image, video, instant message, and voice data, (b) the remote survey unit is one of a handheld unit, laptop, netbook, Personal Digital Assistant, smart phone, radio, cell phone, wireless node, and tablet, and (c) the data terminal is one of a data recording truck and a static data recording terminal.

23. The article of claim 21 storing instructions that enable the system to:
determine a first physical proximity of the remote survey unit to the first node and a second physical proximity of another remote survey unit to the first node; and
communicate the additional fault data to the remote survey unit based on the first physical proximity being less than the second proximity.

24. The article of claim 21 storing instructions that enable the system to determine presence data for the remote survey unit, and communicate the additional fault data to the remote survey unit based on the determined presence data.
